(19) United States
(12) Patent Application Publication
(10) Pub. No.: US 2017/0280863 A1
(43) Pub. Date: Oct. 5, 2017

(54) CLIP FOR TRANSPORTING SANDALS

(71) Applicant: Peter Simon, Big Sur, CA (US)

(72) Inventor: Peter Simon, Big Sur, CA (US)

(21) Appl. No.: 15/474,474

(22) Filed: Mar. 30, 2017

(30) Foreign Application Priority Data
Mar. 31, 2016 (BR) 202016007231-5
Jul. 21, 2016 (BR) 202016016996-3

(51) Int. Cl. A45F 5/06; F16B 45/00

(52) U.S. Cl. CPC A45F 5/06; F16B 45/00

(57) ABSTRACT

A sandal-carrying clip includes a C-shaped one-piece clip, whose lateral surface (1) has a front stem (3) and a rear stem (2) which are symmetrical and parallel to each other in a top view of the object made of flexible plastic, said stems having concentric U-shaped recesses (4, 5), an extension (7), which starts in a top upward arch next to the top face of the lateral surface (1) and ends at the opposite end of the extension (7), next to the sinuous curve of the recess (4) on the front stem (3). The extension (7), in its top end, bends parallel to the front face of the front stem (3), forming the inverted U-shaped front hook (10) in the lateral view of the object. An obstacle (11) is situated inside the hook (10), perpendicular to the inner face (12) of the extension (7). A hole (14), where a clasp may be attached, is situated on the top of the hook (10).

The present utility model relates to a sandal-carrying clip, more specifically to a toe sandal (flip-flop) carrying clip.

### BACKGROUND OF THE INVENTION

People often carry a pair of sandals to the beach, the swimming pool or when traveling. Carrying these sandals may become difficult, since carrying them in hand interferes with the movement and the function of at least one hand. The use of handbags or backpacks is also problematic, since the sandals take up some internal volume in the handbag, in addition to interfering with other items due to their characteristic odor, making the maintenance of hygiene difficult.

There are sandal-carrying devices that make it unnecessary for the user to leave the beach or other leisure location carrying the sandals in their hands, for example, the method of attaching the sandals to a handbag or another object as shown in the document WO 2011/062972. This document discloses an accessory such as a handbag provided with a clip for footwear used for securing a pair of footwear together and attaching it to another object using a locking claw, which is attached to the base of the accessory by means of a string. Such an accessory includes a base, two arms, a safety mechanism, a locking claw-type clip, and pads, in addition to strings.

The problem with this concept is that its design is complex and impractical, since it uses strings and safety means in combination. In addition, the mode of attaching the device to objects only with the aid of a ring, which in turn is connected to a strap securing the base of the handbag-type accessory, does not provide the device with the required firmness when the user is moving. Another problem with this concept is the fact that it keeps the pair of footwear side by side for transportation, thus taking up a larger space, which may interfere with the user's movements.

Another footwear- or sandal-carrying device is shown, for example, in the document US2010/0252592. This document discloses a footwear- or sandal-carrying device composed of a clip to be attached to the clothing, two straps to secure the footwear or sandals, three rings to hold the straps together, and a clasp as an alternative means for attaching the device in question to handbags or backpacks.

The problem with this concept is that the footwear or sandals become loose while in transport, swaying and interfering with the user's movements. Another issue, mentioned above, is the fact that with this approach, the pair of footwear or sandals are side by side for transport, taking up a larger space, which may also interfere with the user's movements.

The present clip originates from observing sandal users on beaches. After using their footwear to walk from their vehicle to the sea, they end up carrying their sandals in their hands when they wish to walk barefoot on the sand. In this sense, the present clip allows the pair of sandals to be suspended, in a compact and convenient manner, on a handbag, a pair of shorts, bathing suit, backpack, beach tent, etc., leaving the hands free.

Another purpose of this development is to avoid the waste and pollution caused by the use of plastic hangers in competitors' displays which, having been used at the point of sale and having no further usefulness or use, are discarded.

### OBJECTS OF THE UTILITY MODEL

One of the objects of the present utility model is to provide a sandal-carrying clip providing the user with safe, comfortable, and practical transportation.

Another object of the utility model is to provide a sandal-carrying clip made of flexible and durable plastic, and which may be exposed to the public in an intelligent manner with reference to the commercial space, due to the design of said clip.

Another object of the utility model is to provide the user with a device for carrying a pair of sandals in a compact and clean manner, since in this way it keeps and holds the pair of sandals in a sole-against-sole configuration, isolating certain portions of the footwear and thus ensuring transportation in a hygienic and convenient manner.

The present utility model allows carrying the sandals or footwear with the aid of a hook suspended, in a compact manner, on a waistband, back pocket, handbag strap, beach tent, or in any recess or flat strap where said hook may be attached, according to the user's preference.

A further object of the utility model is to use the same hook for attaching the pair of sandals to the flat bar on the display, allowing the pairs of sandals or footwear to be displayed in a sole-to-sole configuration, taking up less space in lateral volume, facilitating handling and viewing by the public, and reducing the risk of other pairs surrounding the one being handled being knocked down.

In addition, the hook prevents waste and pollution caused by the use of plastic hangers used in the displays, since such hangers are discarded after their use at the point of sale.

Another object of the utility model is the application of a sticker containing the product number to the surface (1) in the lateral area of the sandal-carrying clip, thus allowing the customer to directly identify the size of the sandals and thus simplifying the buying experience.

Yet another object of the utility model is that the sandal-carrying clip be provided with a hole for inserting a clasp, which allows the sandal-carrying clip to be used as an accessory attached to a handbag, backpack, suitcase, etc. improving the transportation of the product without mixing it with the user's personal belongings and allowing the sandals to be rapidly placed onto and removed from the sandal-carrying clip, making this action simple and practical.

The present clip has two further objects:

1. To display for sale and selection a large number of pairs of sandals available at the point of sale of a self-service system, where this novel way of presenting the product clearly differs from all systems currently used. While the current system (flat hanger) adopted by all manufacturers and brands displays the pairs of sandals side by side, the present clip displays the sandals in a sole-to-sole configuration. This allows for a more compact presentation of the pair, which takes up less space in lateral volume, keeps the pair compacted for easier and more convenient handling and inspection by the potential buyer, reduces the risk of the potential buyer knocking down the other pairs surrounding the one being handled (which often happens with the currently used side-by-side display), provides greater visibility of the exhibited pairs, facilitating selection by the consumer of the preferred version, since the consumer can easily see all sides and parts of each pair. This novel clip system, supported by vertical flat rulers, keeps the product stable in the vertical plane, considerably improving its handling by the consumer public both for removing and for re-placing the pair of sandals on the display, and eliminating interference with the adjacent pairs on the display.

The clip also provides an area on its surface for presenting the brand and its identification.

2. Later use by the consumer allowing them to wear the pair of sandals in a compact and clean manner between uses. By keeping and holding the pair in a sole-to-sole configuration protects the surroundings of the sandals from the dirt that may adhere to the sole due to their use. Using its flat hook for attaching the pair of sandals to the flat bar of the display, the pair may be transported by the user with the help of the same flat hook, suspended in a compact manner on the waistband of shorts or slacks, back pocket, handbag strap, or on any flat strap. In addition, the clip has a hole for inserting a clasp when the user wishes to attach the “clip+sandals” system to a gym bag, backpack, or suitcase for not-on-body transportation. Made of flexible plastic, it allows use and reuse for a long period of time. Insertion of the sandals into the clip is a hooking movement easily performed with one hand.

It is thus clear that this novel sandal-carrying device in the form of a C-shaped clip having recesses for attaching sandals, a hook for suspending the sandals on the flat bar of the display, recess, or any flat strap of the clothing, as well as a device for attaching a clasp to facilitate the transport of sandals in handbags, results in functional improvement in its use compared with similar devices of the related art.

### SUMMARY OF THE UTILITY MODEL

The objects of the present utility model are achieved by the sandal-carrying device composed of a one-piece C-shaped clip, provided with two parallel stems having concentric U-shaped recesses. Such a clip is manufactured of flexible, durable plastic, which allows its use and reuse for a long period of time.

The parallel stems of the one-piece, C-shaped clip have two upward arches extending from the bottom (6) and top (8) faces on the lateral surface (1) of the clip.

On the front stem (3) of the C-shaped clip there is an extension (7) originating at the upward curve of the lateral surface (1). The back stem (2), parallel to the front stem, also has the upward top arch (8) starting on the lateral surface (1), but without an extension. Such an extension follows vertically in a rectangular shape, being provided with a curvature that bends parallel to the front stem from the top of the piece, forming a front hook (10) in the shape of an inverted U, when viewed from one side of the object. A hole (14) is located on the right-hand end, situated on the top of said front hook (10) in the shape of an inverted U.

Considering this design, the pair of sandals is inserted sole-to-sole through the opening of the C-shaped clip. In the sandals, the element connecting the sole straps to the insole in the frontal area of the sandal is known as “interdigit” and is inserted in the U-shaped recesses (4, 5) on the front (3) and rear (2) stems of the clip, firmly attaching the sandals to the clip body. To secure the “clip+sandals” system on the flat bar of the display, a hook (10) of the clip is used, which may also be used for suspending the pair of sandals in a compact manner on a waistband, rear pocket, handbag straps, beach tents, or in any recess or flat strap wherever said hook (10) can be secured according to the user's preference.

The hole (14) situated to the right of the top end of the extension of the front stem known as hook (10), is used for inserting a clasp intended for attaching the sandal-carrying clip to handbags, backpacks, suitcases or to any other desired element.

### BRIEF DESCRIPTION OF THE DRAWINGS

In the following, the main model of the sandal-carrying clip is presented in greater detail with reference to the drawings.

FIG. 1 is a top perspective view of the sandal-carrying clip, where the clip lateral surface (1) is visible;

FIG. 2 is a bottom perspective view of the sandal-carrying clip;

FIG. 3 is a front view of the sandal-carrying clip;

FIG. 4 is a rear view of the sandal-carrying clip;

FIG. 5 is right-hand side view of the sandal-carrying clip;

FIG. 6 is a left-hand side view of the sandal-carrying clip;

FIG. 7 is a sectioned view (A-A) of the left-hand side view (FIG. 6), which shows the extension (7) and front hook (10) sections in detail;

FIG. 8 is a top view of the sandal-carrying clip;

FIG. 9 is an image equivalent to the rear view (FIG. 4) and shows the sandals, sole to sole, inserted into the hanger clip, forming the “clip+sandals” system;

FIG. 10 is an image equivalent to a detail of the left-hand side view (FIG. 6), where the sole-to-sole sandals and the lateral surface (1) may be observed;

FIG. 11 is an image representing the “clip+sandals” system in its front view (FIG. 3);

FIG. 12 is an image exemplifying the carrying clips inserted in a flat bar of a display;

FIG. 13 is an image exemplifying the “clip+sandals” systems inserted in a flat bar of a display.

### DETAILED DESCRIPTION OF THE UTILITY MODEL

The subject of the present utility model is manufactured in flexible, highly durable plastic, which allows its use and reuse for a long period of time.

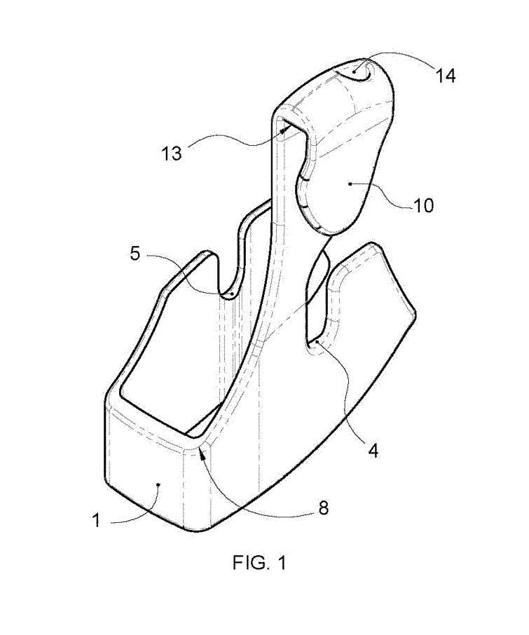

According to the main model of the sandal-carrying clip, making reference to the figures outlined above and according to FIG. 1, the present model includes a one-piece C-shaped clip having a lateral surface (1), as well as a front stem (3) and rear stem (2) parallel to each other.

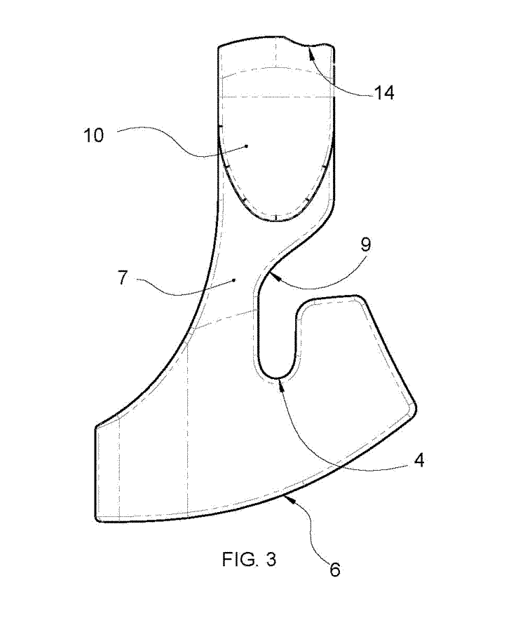

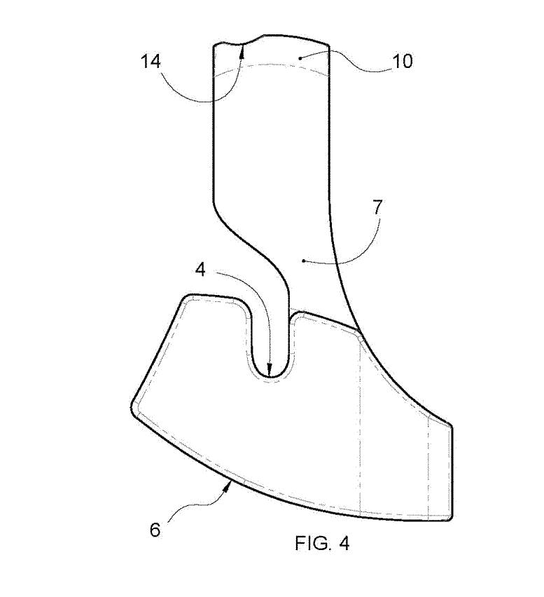

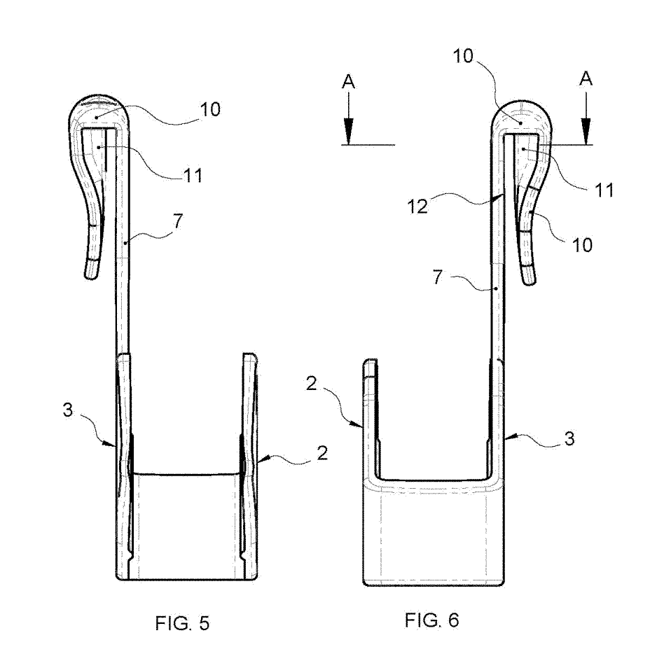

The rear stem (2) has a U-shaped recess (5), and the front stem (3) has another U-shaped recess (4). The rear (2) and front (3) stems have a shape of a bottom upward arch (6) and top upward arch (8), which originate in the area of contact of the stems with the lateral surface (1), as better seen in FIGS. 3 and 4.

Also according to FIGS. 3 and 4, the front stem (3) has an extension (7), which originates at the top upward arch (8) and the top extension of the recess (4), which forms a sinuous upward arch, both the upward and the sinuous arches becoming parallel in the front view of the object, in the top area of the extension (7), area of the front hook (10).

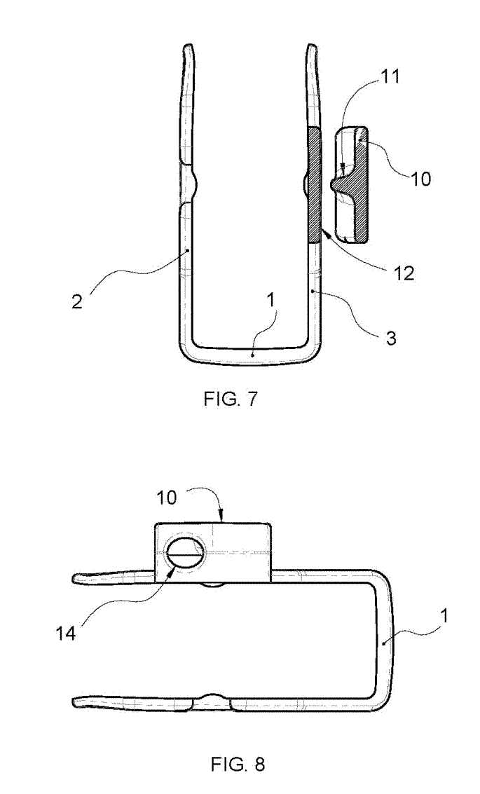

Note in FIGS. 6 and 7, in the section A-A, that in the inner area of the hook (10) and across the direction of the hook, an element (11) in the form of a wall or obstacle is situated perpendicularly to the inner face (12) of the extension (7), allowing a tighter fit of the front hook (10) in the flat bars of the displays, in waistbands of slacks or pieces of clothing.

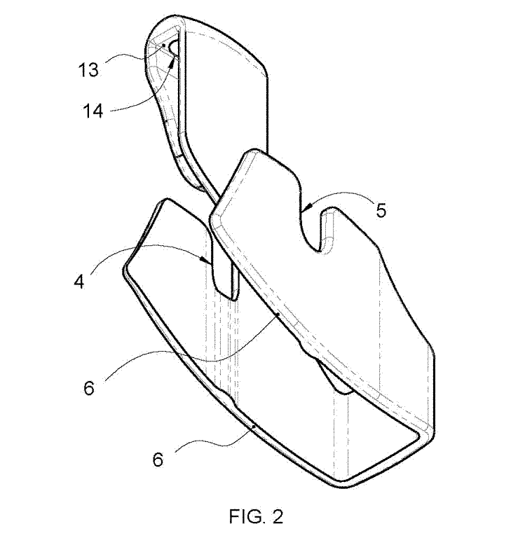

In FIGS. 8, 1 and 2, there is a hole (14) situated at the left end (in front view of the object) on the top of the front hook (10). This hole is used for inserting a clasp, facilitating the use of the sandal-carrying clip as an accessory by simplifying the attachment of the clip to handbags, backpacks, suitcases, etc.

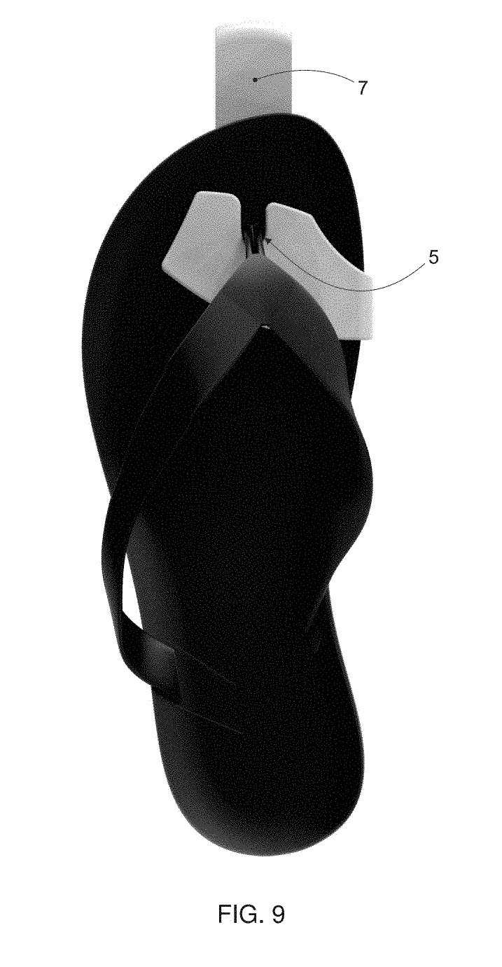

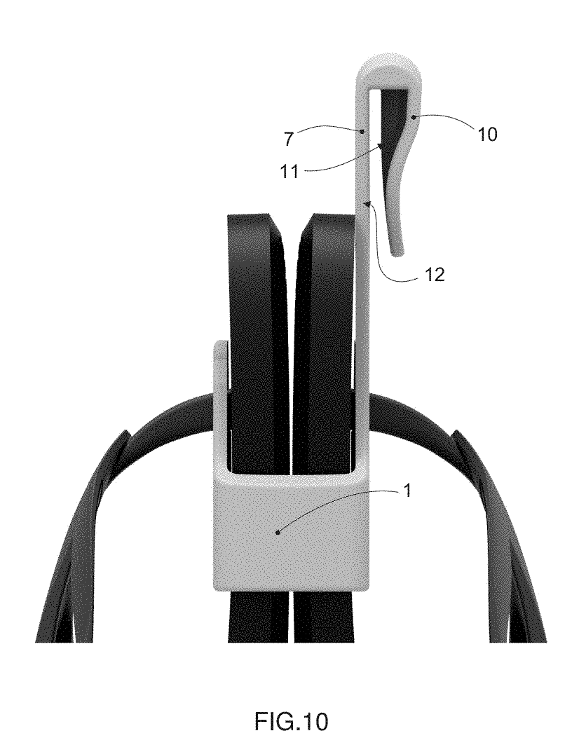

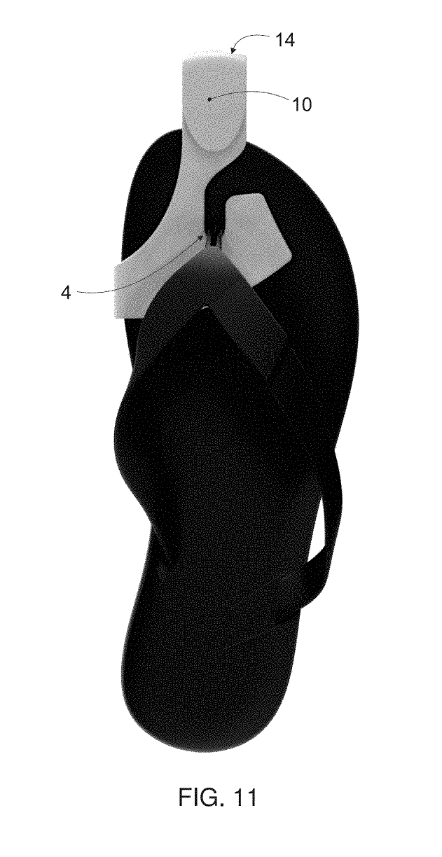

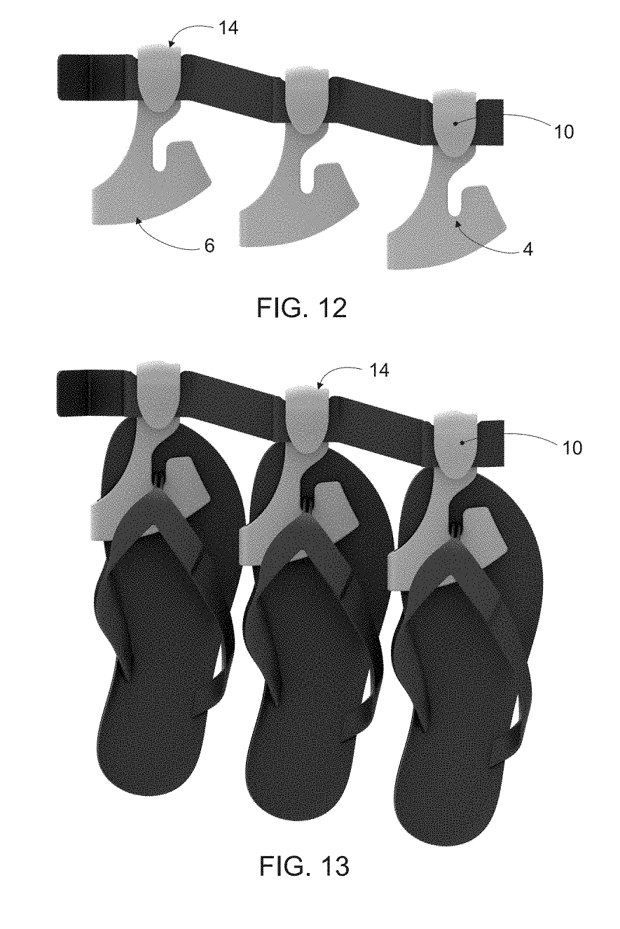

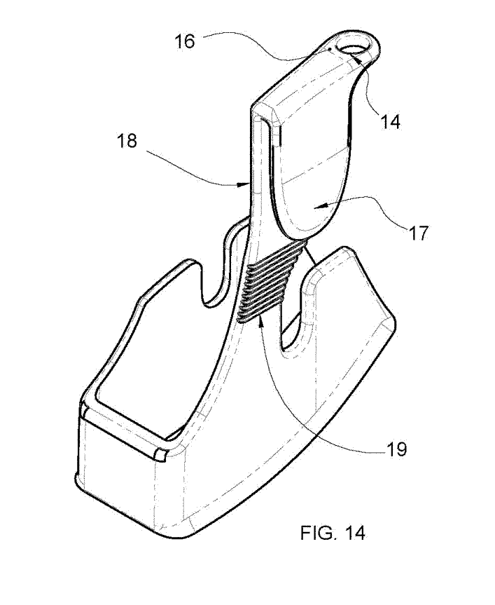

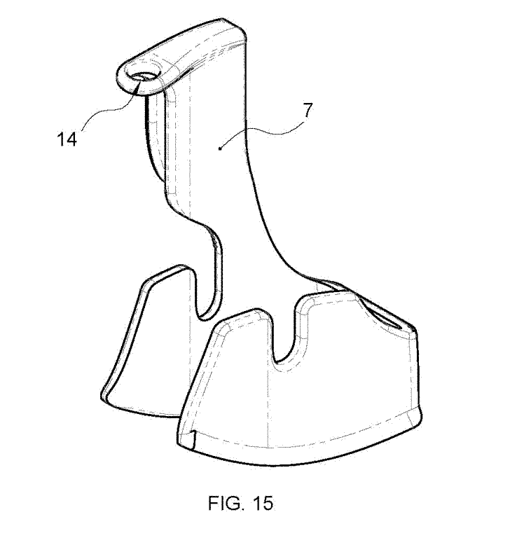

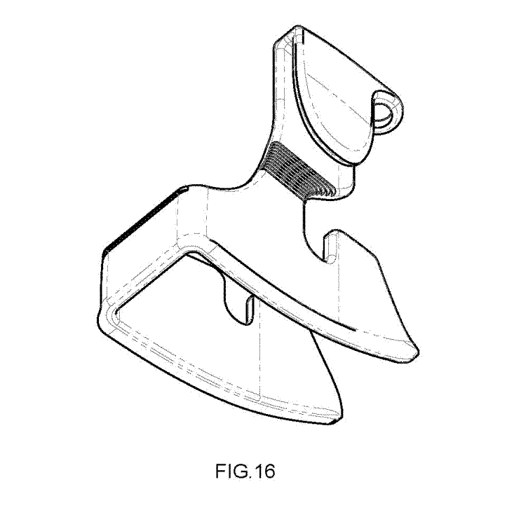

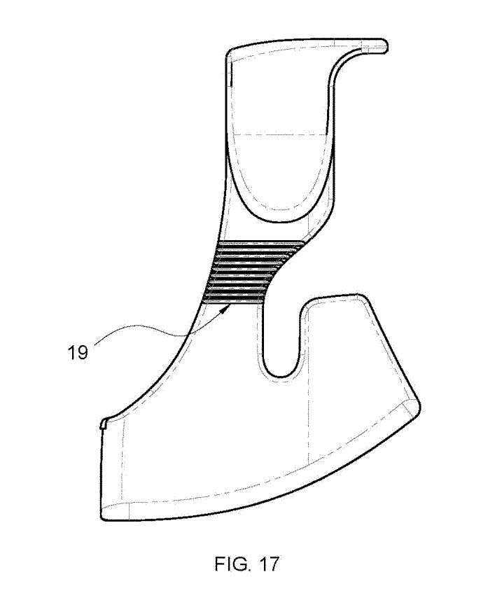

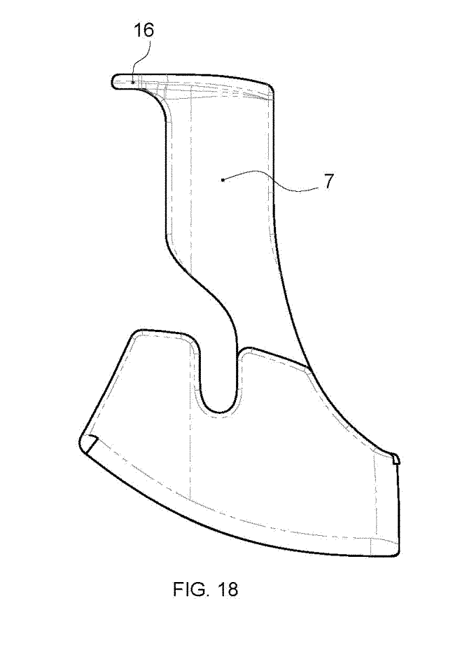

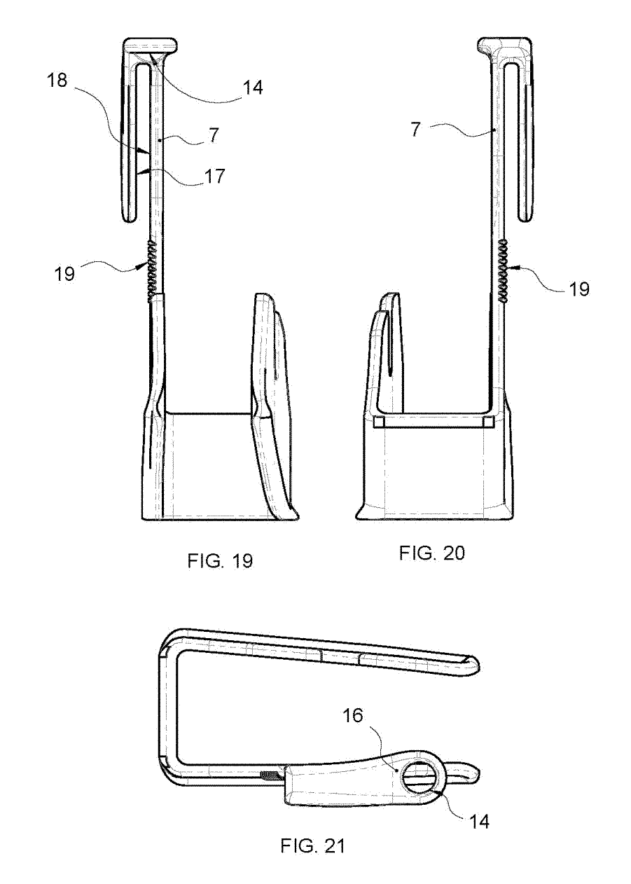

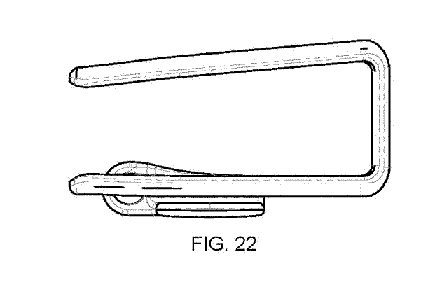

The use of the sandal-carrying clip is very simple and practical, without prejudice to the firmness of the sandals or to the user's convenience during the transport of said sandals, as shown in FIGS. 9 through 13.

To use the sandal-carrying clip (1), it is sufficient to insert the pair of sandals arranged sole to sole into the clip through the opening of the C, and securing it via its “interdigits” in the U-shaped recesses (4 and 5) in the front (3) and rear (2) stems.

The pressure of the flexible plastic material of the one-piece C-shaped clip (1) will hold the pair of sandals firmly in place for transport.

The hook (10) will be used for attaching the pair of sandals to the flat bar of the display, as well as for allowing the user to carry said pair of sandals, suspended in a compact manner, on a waistband of shorts or slacks, a rear pocket, strap of a handbag, beach tent, or in any recess or flat strap.

The hole (14) is intended for insertion of a clasp, allowing the use of the sandal-carrying clip as an accessory attached to a handbag, backpack, suitcase, etc.

One design variant of the main model of the sandal-carrying clip is shown in greater detail with reference to the drawings:

FIG. 14 is a top front perspective view of the design variant of the sandal-carrying clip;

FIG. 15 is a top rear perspective view of the design variant of the sandal-carrying clip;

FIG. 16 is a bottom front perspective view of the design variant of the sandal-carrying clip;

FIG. 17 is a front view of the design variant of the sandal-carrying clip;

FIG. 18 is a rear view of the design variant of the sandal-carrying clip;

FIG. 19 is a right-hand side view of the design variant of the sandal-carrying clip;

FIG. 20 is a left-hand side view of the design variant of the sandal-carrying clip;

FIG. 21 is a top view of the design variant of the sandal-carrying clip;

FIG. 22 is a bottom view of the design variant of the sandal-carrying clip.

According to one design variant of the sandal-carrying clip, with reference to the figures outlined above and according to FIGS. 14 and 19, this variant has an asymmetric extension with respect to the front view of the object, situated at the top end of the straight front hook, in the shape of an inverted U. Still with respect to FIGS. 14 and 19, this extension (16) has the same hole (14) for inserting a clasp and the front hook (17) parallel to the inner face (18).

Also with respect to the top flat part of the straight hook (16) and according to FIGS. 21 and 22, it has a greater width and is rounded at the elongated distal end, where the hole (14) is located, this flat top part having a smaller width and a rectangular shape at the opposite end.

FIGS. 14, 16, 17, 19, and 20 show, on the design variant, horizontal elevations (19) in the form of a texture extending across the front face of the extension (7), which extends vertically in a rectangular shape.

The design variant presented here is a variation of the main model of the sandal-carrying clip, where minor changes of form were made, keeping the technical-functional and corporal unity of said main model.

What is claimed is:

1. A sandal-carrying clip, characterized in that it includes a one-piece, C-shaped clip, provided with a rear stem (2) and a front stem (3), parallel to each other, the rear stem (2) having a recess (4) on its top surface, and the front stem (3) also having a recess (5) on its top surface, said recesses (4, 5) being concentric and U-shaped, the rear (2) and front (3) stems having, on their bottom faces, a bottom upward arch, originating from its contact with the lateral surface (1); the front stem (3) having a rectangular extension (7), which starts in a curved shape, on the surface of a top upward arch (8) originating on the top of the lateral surface (1), and the other side of the extension (7) starting at the top sinuous arch resulting from the extension of the recess (4) of the front stem (3), the extension (7) having at its top end a hole (14) and bending to the front of the piece, forming a front hook (10), this front hook (10) having on its inner face a wall or obstacle (11) perpendicular to the inner face (12) of the extension (7), transversal to the front hook (10).

2. The sandal-carrying clip as recited in claim 1, characterized by an inverted U-shaped front hook (17), the front hook (17) being parallel to the inner face (18) of the vertical extension (7) and has an elongated distal end, where the hole (14) is situated, said top flat elongated part having a greater width and rounded shape at its elongated distal end, where the hole (14) is situated, the width of this top flat part being smaller and of rectangular shape at the opposite end, where horizontal elevations in the form of a texture extending across the front face of the extension (7) are also located.

3. The sandal-carrying clip as recited in claim 1, characterized in that it is manufactured of a flexible plastic material.
